(19) United States
(12) Patent Application Publication
(10) Pub. No.: US 2026/0289218 A1
(43) Pub. Date: Sep. 24, 2026

(54) Themed Financial Card and Card Skin

(71) Applicant: Chanmattee Bachoo, Brooklyn, NY (US)

(72) Inventor: Chanmattee Bachoo, Brooklyn, NY (US)

(21) Appl. No.: 19/353,170

(22) Filed: Oct. 8, 2025

Related U.S. Application Data
(60) Provisional application No. 63/774,977, filed on Mar. 20, 2025.

(51) Int. Cl. G06K 19/077

(52) U.S. Cl. CPC G06K 19/07707

(57) ABSTRACT

The present invention relates to a culturally inspired financial transaction card that incorporates Themed visuals. The card includes a durable card body with standard financial features such as an EMV chip, magnetic stripe, card number, and expiration date. The front surface of the card includes customizable themed imagery, including steel drums, palm trees, or regional landscapes. The themed imagery can be printed, embossed, or configured as raised tactile elements to distinguish between card types by touch. In some embodiments, the card includes a biometric sensor for fingerprint authentication. The card is compatible with a mobile application that enables users to customize the displayed cultural elements and configure usage parameters such as transaction limits or rewards. In one embodiment, a removable card skin or overlay with non-damaging adhesive backing is disclosed that enables users to personalize and interchange themed designs without obstructing the card's usability.

### CROSS-REFERENCE TO RELATED APPLICATION

The present application claims priority to, and the benefit of, U.S. Provisional Application No. 63/774,977, which was filed on Mar. 20, 2025, and is incorporated herein by reference in its entirety.

### FIELD OF THE INVENTION

The present invention generally relates to customizable financial instruments. More specifically, the invention relates to themed financial cards (i.e., Caribbean theme) and removable card skins or overlays. The invention integrates themed imagery, such as steel drums, palm trees, regional flags, and landscapes, onto the card surface. The card provides the functional integrity of traditional financial cards, including compatibility with EMV chips, magnetic stripes, contactless payment, and online transactions. Alternative embodiments may include removable card skins or overlays with non-damaging adhesive backing, enabling users to personalize and interchange themed designs. Accordingly, the present disclosure makes specific reference thereto. Nonetheless, it is to be appreciated that aspects of the present invention are also equally applicable to other like applications, devices, and methods of manufacture.

### BACKGROUND

By way of background, financial cards such as debit and credit cards issued by banks and other financial institutions are widely used for everyday financial transactions, including in-person purchases, online payments, ATM withdrawals, and more. Despite their essential functionality and use, the design of the conventional financial cards is often plain, generic, and lacking in personal or cultural significance. While some institutions offer decorative or branded cards, the available options are typically limited in scope and do not accommodate a broad range of individual aesthetic preferences.

As consumers increasingly seek products that reflect their identity, heritage, or lifestyle, there is a growing demand for financial cards that incorporate visual appeal and cultural representation. Specifically, individuals with connections to specific regions, such as the Caribbean, desire financial cards that embody the vibrant culture, music, landscapes, and traditions associated with those regions.

Therefore, there exists a long-felt need in the art for a financial transaction card that offers a culturally meaningful design beyond conventional, generic card aesthetics. There is a long-felt need for debit and credit cards that reflect the cultural identity, personal style, or heritage of the cardholder. Additionally, there exists a long-felt need for customizable financial cards that enable users to engage with and personalize their banking experience through culturally themed visuals. Furthermore, there exists a long-felt need in the art for themed financial cards that maintain the full transactional capabilities of traditional cards while offering enhanced security, personalization, and emotional connection. More specifically, there is a long-felt need for themed financial cards (i.e., Caribbean theme) that incorporate regional imagery such as steel drums, palm trees, and local landmarks while remaining compatible with EMV, magnetic stripe, and contactless technologies. Finally, there is a long-felt need in the art for a series of themed debit and credit card designs that enable users to create custom cards with the associated designs to use at businesses and online vendors.

The subject matter disclosed and claimed herein, in one embodiment, comprises a Themed financial transaction card. The card includes a durable card body having a front surface and a rear surface, with standard payment components such as an EMV chip, magnetic stripe, card number, expiration date, and issuer logo. The front surface has one or more themed design elements, including musical instruments, landscapes, regional flags, wildlife, and festivals, which may be printed, embossed, or raised for tactile interaction. In some embodiments, the card includes an embedded biometric sensor for fingerprint authentication. The card may also pair with a mobile application that enables users to customize the visual elements displayed on the card and configure transaction settings such as spending limits, activation status, and reward programs.

In another embodiment, a removable themed card skin may be provided, comprising a decorative layer with a design and a non-damaging, residue-free adhesive backing. The card skin is configured to be applied over an existing financial card to customize its appearance without obstructing the visibility or use of its functional or operational components and may be removed or replaced to enable ongoing personalization by the user.

In this manner, the themed financial card of the present invention fulfills the long-felt need for a culturally expressive and functional transaction tool. The invention enables users to showcase cultural pride and individuality through an everyday financial product. The card further accommodates tactile markers and raised design elements for accessible card identification by touch, and in some embodiments, visual features may illuminate upon successful transactions to provide feedback and engagement. The card and associated skin feature unique designs, such as, for example, steel drums, mallets, pan drums, specific geographic locations, and more. The card can maintain its usual use as a debit and/or credit card in retail stores and at online vendors.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a financial transaction card. The financial transaction card comprises a card body having a front surface and a rear surface, at least one themed visual element is disposed on the front surface, a card number, expiration date, and issuer logo are disposed on the front surface, an EMV chip is embedded in the card body and configured for secure chip-and-pin transactions, wherein the card is configured to function as a debit card, credit card, gift card, or other financial transaction card. The themed visual element is selected from the group consisting of, for example, a steel drum, pan drum, palm tree, beach, street market, regional flag, festival, and native wildlife.

In another aspect, a financial transaction card is disclosed. The financial transaction card includes a card body having a front surface and a rear surface. Themed imagery is disposed on the front surface, wherein the imagery is formed in a raised pattern providing tactile identification, and a biometric sensor is disposed on the card body and configured to detect a fingerprint of a user.

In another embodiment, a removable decorative skin for application to a financial transaction card is disclosed. The skin comprises a front surface and a rear surface, the front surface includes at least one Themed design disposed thereon, an adhesive layer is disposed on the rear surface of the skin body, the adhesive layer is configured to enable the skin to adhere to a financial transaction card and to be removed without damaging the card, wherein the decorative skin is configured to customize the appearance of the financial transaction card without obstructing its functionality, and wherein the skin is replaceable to enable re-customization. One or more precut openings or transparent zones are formed in the skin body to maintain visibility or accessibility to one or more functional or operational components of the financial transaction card.

In one embodiment, a system is disclosed. The system comprises a themed financial transaction card, which includes a front surface with customizable visual elements, including cultural imagery. A mobile application is installed on a computing device and is configured to communicate with the financial transaction card. The mobile application includes a graphical interface for selecting and transmitting one or more themed design elements for dynamically displaying on the financial transaction card and one or more control options configured to remotely activate, deactivate, block, or configure the card's usage parameters, including transaction limits and rewards.

In yet another aspect, at least one style element embedded in the card is configured to illuminate upon successful completion of a financial transaction.

In a further embodiment, the card body is composed of a combination of plastic and metallic material and is configured for near-field communication (NFC) payment transactions.

In still another embodiment, the raised themed imagery is configured to identify card type based on tactile features, wherein different tactile patterns correspond to at least a debit card, a credit card, and a prepaid card.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of a themed financial card of the present invention in accordance with the disclosed structure;

FIG. 2 illustrates a rear perspective view of the themed financial card of the present invention in accordance with the disclosed structure;

FIG. 3 illustrates an exemplary mobile application interface of a mobile application configured to be paired with the themed financial card of the present invention in accordance with the disclosed structure;

FIG. 4 illustrates another embodiment of the themed financial card in accordance with the disclosed structure; and

FIG. 5 illustrates a themed financial card skin in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a financial transaction card that offers a culturally meaningful or themed design beyond conventional, generic card aesthetics. There is a long-felt need for debit and credit cards that reflect the cultural identity, personal style, or heritage of the cardholder. Additionally, there exists a long-felt need for customizable financial cards that enable users to engage with and personalize their banking experience through culturally themed visuals. Furthermore, there exists a long-felt need in the art for themed financial cards that maintain the full transactional capabilities of traditional cards while offering enhanced security, personalization, and emotional connection. More specifically, there is a long-felt need for themed financial cards (i.e., Caribbean themed) that incorporate regional imagery such as steel drums, palm trees, and local landmarks while remaining compatible with EMV, magnetic stripe, and contactless technologies. Finally, there is a long-felt need in the art for a series of themed debit and credit card designs that enable users to create custom cards with the associated designs to use at businesses and online vendors.

The present invention, in one exemplary embodiment, is a financial transaction card. The financial transaction card comprises a card body having a front surface and a rear surface, at least one themed visual element is disposed on the front surface, a card number, expiration date, and issuer logo are disposed on the front surface, an EMV chip is embedded in the card body and configured for secure chip-and-pin transactions, wherein the card is configured to function as a debit card, credit card, gift card, or other financial transaction card. The themed visual element is selected from the group consisting of a steel drum, pan drum, palm tree, beach, street market, regional flag, festival, and native wildlife.

Reference will now be made in detail to the present preferred embodiments of the invention, examples of which are illustrated in the accompanying drawings. Wherever possible, the same reference numerals are used in the drawings and the description to refer to the same or like parts.

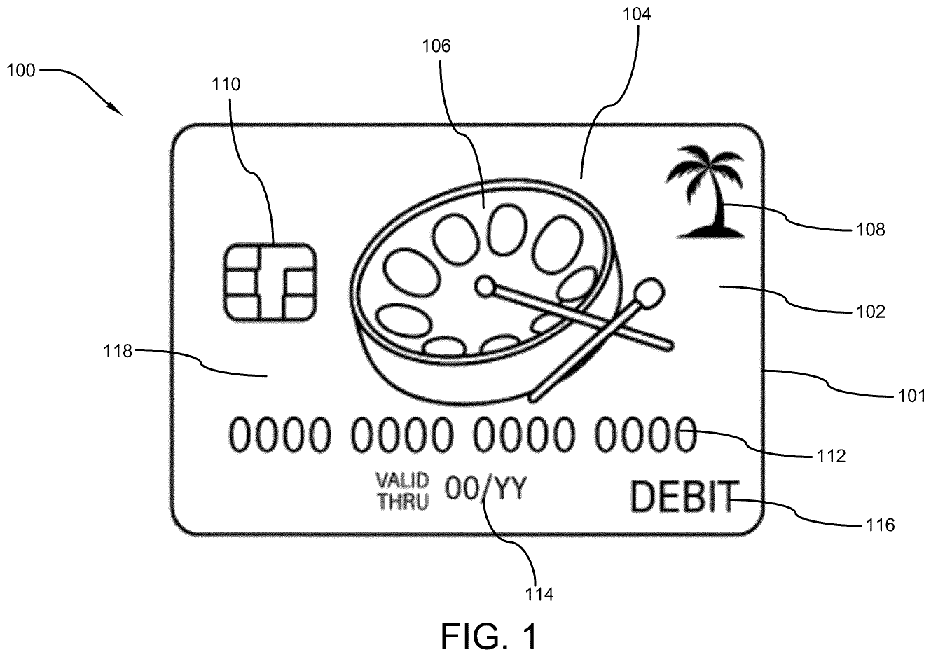

Referring initially to the drawings, FIG. 1 illustrates a front perspective view of a themed financial card of the present invention in accordance with the disclosed structure. The themed financial card 100 of the present invention is a specially designed and culturally inspired financial card, such as a credit card, debit card, gift card, or any other financial card that includes themed visual configurations thereon. The themed financial card 100 is configured to maintain the functionality of standard payment cards, however, the appearance is enhanced to create a unique, cultural, and potentially collectible user experience. The themed financial card 100 can be used for payments in retail stores, for online transactions, ATM access, various banking functions, and more.

More specifically, the themed financial card 100 has a durable card body 101. The front surface 102 of the card body 101 includes themed imagery or configuration 104 which includes, for example, musical instruments 106 such as steel drums and/or pan drums which are used in the associated theme. The front surface 102 may also have associated geographic displays or landscapes 108 such as a palm tree, beach, street market, or more disposed thereon. In some embodiments, the themed financial card 100 may also include images of regional flags, festivals, or native wildlife.

The front surface 102 may have a chip 110 such as an EMV chip, disposed therein. The chip 110 can be used for secure chip-and-pin transactions. In one embodiment, the front surface 102 also includes a card number 112, card expiry date 114, and an issuer logo 116. It should be noted that additional information such as card owner's name, bank information, and more, may also be printed or embossed on the front surface 102.

In some embodiments, the themed imagery or configuration 104 can be printed or embossed, and in other embodiments, the themed imagery or configuration 104 may be configured in a raised pattern, which can also function as tactile markers to identify a card, a card type, and/or a card orientation. The raised themed imagery can be configured to identify card type based on tactile features, wherein different tactile patterns correspond to at least a debit card, a credit card, and a prepaid card. The card 100 may also include a fingerprint or biometric sensor 118 for only enabling authorized access and payments to improve security and making the card 100 harder to clone or misuse. As a non-limiting example, a raised steel drum may tactilely indicate a debit card, and a raised palm tree may tactilely indicate a credit card.

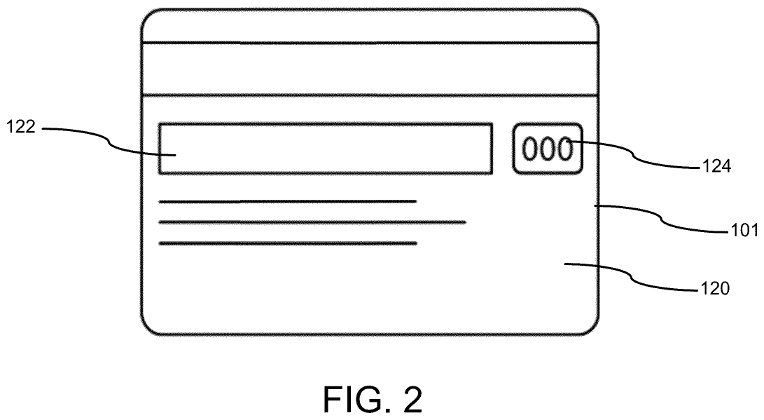

FIG. 2 illustrates a rear perspective view of the themed financial card of the present invention in accordance with the disclosed structure. The rear surface 120 of the card body 101 includes a magnetic strip 122 for swiping the card 100 at conventional point-of-sale (POS) terminals. A CVV number 124 may be embossed or printed on the rear surface 120 for facilitating online payments using the card. In another embodiment, the rear surface 120 also includes a card number, card expiry date, and an issuer logo (not illustrated). It should be noted that the themed financial card 100 can be adapted to be contactless (using NFC or RFID technology) and can be made from one or a combination of plastic or a metallic material.

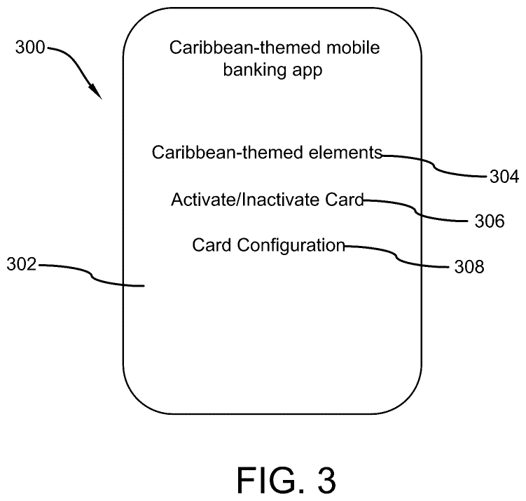

FIG. 3 illustrates an exemplary mobile application interface of a mobile application configured to be paired with the themed financial card of the present invention in accordance with the disclosed structure. In the present embodiment, the themed financial card 100 is designed to be paired with a mobile application 300 wherein the mobile application 302 can control the design and configuration of the card 100. The interface 302 provides a “themed elements” option 304 which enables a user to select one or more themed elements for digital display on the front surface of the themed financial card 100. The themed financial card 100 provides a customized display based on the selection of the themed elements through the mobile application 300.

The themed financial card 100 can be remotely activated and deactivated or blocked using the “Activate/Inactivate Card” option 306 provided by the application 300. The card 100 can be configured for parameters such as transaction limit, withdraw limit, reward points, and more using the “Card Configuration” option 308.

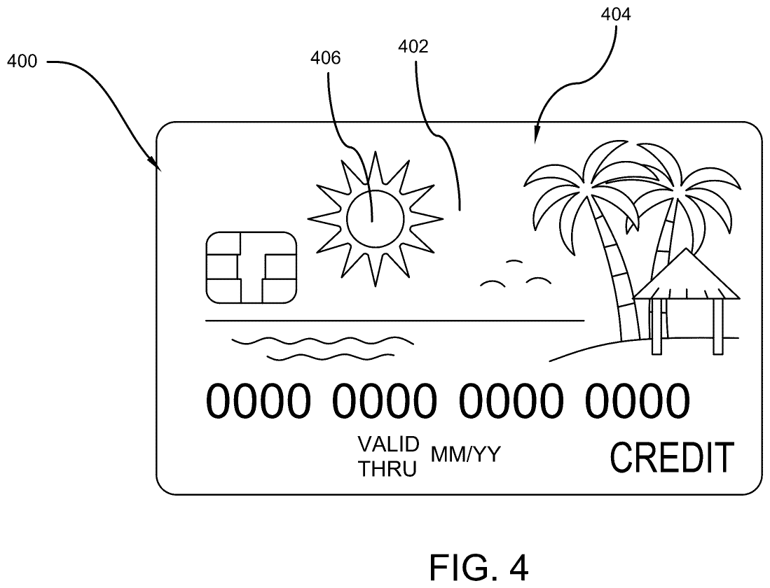

FIG. 4 illustrates another embodiment of the themed financial card in accordance with the disclosed structure. In the present invention, the themed financial card 400 includes a beach imagery 402 as the background of the front surface 404. The card 400 is a credit card but can be in the form of any financial product. In the preferred embodiment, upon successful transaction using the card 400, one or more elements of the beach style imagery 402 may illuminate, mimicking the act of the element, such as the sun 406 illuminating in yellow color. All other elements described in FIG. 1 are included in the card 400 of the present embodiment, and it should be noted that any conventional functional elements of financial products can be included in the themed financial cards (i.e., Caribbean theme) of the present invention.

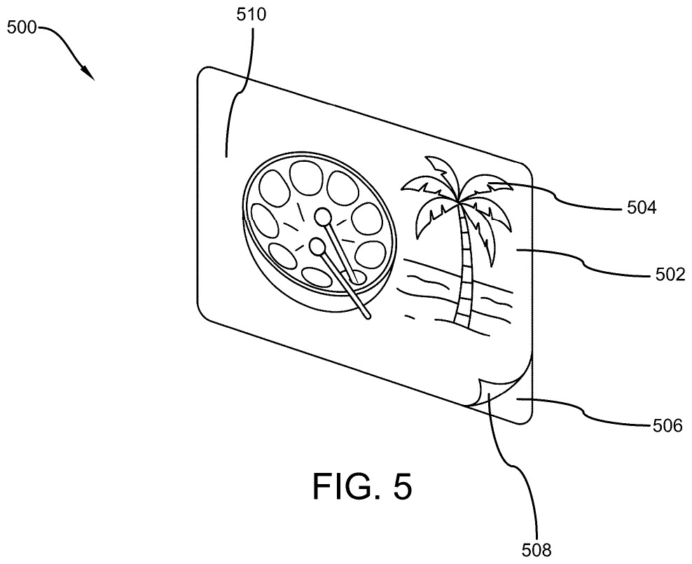

FIG. 5 illustrates a themed financial card skin in accordance with one embodiment of the present invention. In the present embodiment, a themed financial card skin or adhesive overlay 500 is provided that can be used for customizing an existing financial card with a geographic or cultural design. As illustrated, the themed financial card skin or adhesive overlay 500 includes a first or one surface 502 which has, for example, a cultural design 504 disposed thereon. A second or another surface 506 of the skin or adhesive overlay 500 has an adhesive 508 disposed thereon which is used for applying the skin or adhesive overlay 500 onto an existing financial card to customize the card without any professional help. The adhesive 508 is specifically designed to be removable and non-damaging to cards and can be in the form of hot melt adhesive or residue-free vinyl adhesive. The skin or adhesive overlay 500 can be precut with openings to ensure the functional or operational components of a card are visible and unshielded for use. Preferably, one or more precut openings or transparent zones 510 are formed in the skin body to maintain visibility or accessibility to one or more functional or operational components (i.e., EMV chip, magnetic strip, et. al.) of the financial transaction card. Furthermore, the skin or adhesive overlay 500 does not obstruct the utilization (i.e., EMV chip, magnetic strip, et. al.) of any financial card and can be replaced with a new skin to customize the appearance of the card.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “themed financial card”, “financial transaction card”, and “card” are interchangeable and refer to the themed financial card 100, 400 of the present invention.

Notwithstanding the foregoing, the themed financial card 100, 400 of the present invention can be of any suitable configuration as is known in the art without affecting the overall concept of the invention, provided that it accomplishes the above-stated objectives. One of ordinary skill in the art will appreciate that the themed financial card 100, 400 as shown in the FIGS. are for illustrative purposes only, and that many other configurations of the themed financial card 100, 400 are well within the scope of the present disclosure. Although the dimensions of the themed financial card 100, 400 are important design parameters for user convenience, the themed financial card 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A themed financial card comprising:
a financial card having a front surface and a rear surface; and
a visual configuration;
wherein said visual configuration is selected from the group consisting of a cultural display and a geographic display;
wherein said visual configuration is a first adhesive overlay attachable to one of said front surface and said rear surface;
wherein said visual configuration is a second adhesive overlay attachable to another one of said front surface and said rear surface;
wherein said visual configuration is displayed on said front surface and said rear surface;
wherein at least one of said first adhesive overlay and said second adhesive overlay having at least one opening for unshielding an operational component of said financial card; and
further wherein said financial card is selected from the group consisting of a credit card, a debit card, and a gift card.

2. The themed financial card of claim 1, wherein said cultural display includes images on said front surface selected from the group consisting of a musical instrument, a steel drum, a pan drum, a regional flag, a festival, and a native wildlife.

3. The themed financial card of claim 2, wherein said geographic display includes images on said rear surface selected from the group consisting of a palm tree, a beach, and a street market.

4. The themed financial card of claim 3, wherein said front surface having an EMV chip disposed therein.

5. The themed financial card of claim 4, wherein said front surface including a card number, a card expiry date, and an issuer logo.

6. The themed financial card of claim 5, wherein said front surface further including a card owner's name and a bank information.

7. A themed financial card comprising:
a financial card having a front surface and a rear surface; and
a visual configuration;
wherein said visual configuration is selected from the group consisting of a cultural display and a geographic display;
wherein said visual configuration is a first embossment including a first raised pattern on one of said front surface and said rear surface;
wherein said visual configuration is a second embossment including a second raised pattern on another one of said front surface and said rear surface;
wherein said visual configuration is displayed on said front surface and said rear surface;
and
further wherein said financial card is selected from the group consisting of a credit card, a debit card, and a gift card.

8. The themed financial card of claim 7, wherein said cultural display includes images on said front surface selected from the group consisting of a musical instrument, a steel drum, a pan drum, a regional flag, a festival, and a native wildlife.

9. The themed financial card of claim 8, wherein said geographic display includes images on said rear surface selected from the group consisting of a palm tree, a beach, and a street market.

10. The themed financial card of claim 9, wherein said front surface having an EMV chip disposed therein.

11. The themed financial card of claim 10, wherein said front surface including a card number, a card expiry date, and an issuer logo.

12. The themed financial card of claim 11, wherein said front surface further including a card owner's name and a bank information.

13. The themed financial card of claim 7, wherein said first raised pattern tactilely identifies one of said financial cards selected from the group consisting of a credit card, a debit card, and a gift card.

14. The themed financial card of claim 13, wherein said second raised pattern tactilely identifies another one of said financial cards selected from the group consisting of a credit card, a debit card, and a gift card.

15. A method of theming a financial card, the method comprising the steps of:
providing a financial card having a front surface and a rear surface and a visual configuration, wherein said visual configuration is selected from the group consisting of a cultural display and a geographic display, wherein said visual configuration is a first adhesive overlay, further wherein said visual configuration is a second adhesive overlay;
attaching said first adhesive overlay to one of said front surface and said rear surface;
attaching said second adhesive overlay to another one of said front surface and said rear surface;
displaying said visual configuration on said front surface and said rear surface, wherein at least one of said first adhesive overlay and said second adhesive overlay having at least one opening for unshielding an operational component of said financial card, and further wherein said financial card is selected from the group consisting of a credit card, a debit card, and a gift card.

16. The method of theming a financial card of claim 15, wherein said cultural display includes images on said front surface selected from the group consisting of a musical instrument, a steel drum, a pan drum, a regional flag, a festival, and a native wildlife.

17. The method of theming a financial card of claim 16, wherein said geographic display includes images on said rear surface selected from the group consisting of a palm tree, a beach, and a street market.

18. The method of theming a financial card of claim 17, wherein said front surface having an EMV chip disposed therein.

19. The method of theming a financial card of claim 18, wherein said front surface including a card number, a card expiry date, and an issuer logo.

20. The method of theming a financial card of claim 19, wherein said front surface further including a card owner's name and a bank information.
